(19) United States
(12) Patent Application Publication
(10) Pub. No.: US 2006/0118192 A1
(43) Pub. Date: Jun. 8, 2006

(54) Method of manufacturing an insulated pipeline

(76) Inventor: Robert Lance Cook, Katy, TX (US)

Correspondence Address: HAYNES AND BOONE, LLP, 901 MAIN STREET, SUITE 3100, DALLAS, TX, 75202, US

(21) Appl. No.: 10/525,888

(22) PCT Filed: Aug. 8, 2003
(86) PCT No.: PCT/US03/24779

§ 371 Date: Sep. 19, 2005

Related U.S. Application Data
(60) Provisional application No. 60/407,442, filed on Aug. 30, 2002.

(51) Int. Cl. F16L 9/18

(52) U.S. Cl. 138/114; 138/108; 138/112; 138/113

(57) ABSTRACT

A method of manufacturing an insulated pipeline.

### CROSS REFERENCE TO RELATED APPLICATIONS

The present application is the National Stage patent application for PCT patent application serial number PCT/US2003/024779, attorney docket number 25791.125.02, filed on Aug. 08, 2003, which claimed the benefit of the filing dates of (1) U.S. provisional patent application Ser. No. 60/407,442, attorney docket no 25791.125, filed on Aug. 30, 2002, the disclosure of which is incorporated herein by reference.

The present application is related to the following: (1) U.S. patent application Ser. No. 09/454,139, attorney docket no. 25791.03.02, filed on Dec. 3, 1999, (2) U.S. patent application Ser. No. 09/510,913, attorney docket no. 25791.7.02, filed on Feb. 23, 2000, (3) U.S. patent application Ser. No. 09/502,350, attorney docket no. 25791.8.02, filed on Feb. 10, 2000, (4) U.S. Pat. No. 6,328,113, (5) U.S. patent application Ser. No. 09/523,460, attorney docket no. 25791.11.02, filed on Mar. 10, 2000, (6) U.S. patent application Ser. No. 09/512,895, attorney docket no. 25791.12.02, filed on Feb. 24, 2000, (7) U.S. patent application Ser. No. 09/511,941, attorney docket no. 25791.16.02, filed on Feb. 24, 2000, (8) U.S. patent application Ser. No. 09/588,946, attorney docket no. 25791.17.02, filed on Jun. 7, 2000, (9) U.S. patent application Ser. No. 09/559,122, attorney docket no. 25791.23.02, filed on Apr. 26, 2000, (10) PCT patent application serial no. PCT/US00/18635, attorney docket no. 25791.25.02, filed on Jul. 9, 2000, (11) U.S. provisional patent application Ser. No. 60/162,671, attorney docket no. 25791.27, filed on Nov. 1, 1999, (12) U.S. provisional patent application Ser. No. 60/154,047, attorney docket no. 25791.29, filed on Sep. 16, 1999, (13) U.S. provisional patent application Ser. No. 60/159,082, attorney docket no. 25791.34, filed on Oct. 12, 1999, (14) U.S. provisional patent application Ser. No. 60/159,039, attorney docket no. 25791.36, filed on Oct. 12, 1999, (15) U.S. provisional patent application Ser. No. 60/159,033, attorney docket no. 25791.37, filed on Oct. 12, 1999, (16) U.S. provisional patent application Ser. No. 60/212,359, attorney docket no. 25791.38, filed on Jun. 19, 2000, (17) U.S. provisional patent application Ser. No. 60/165,228, attorney docket no. 25791.39, filed on Nov. 12, 1999, (18) U.S. provisional patent application Ser. No. 60/221,443, attorney docket no. 25791.45, filed on Jul. 28, 2000, (19) U.S. provisional patent application Ser. No. 60/221,645, attorney docket no. 25791.46, filed on Jul. 28, 2000, (20) U.S. provisional patent application Ser. No. 60/233,638, attorney docket no. 25791.47, filed on Sep. 18, 2000, (21) U.S. provisional patent application Ser. No. 60/237,334, attorney docket no. 25791.48, filed on Oct. 2, 2000, (22) U.S. provisional patent application Ser. No. 60/270,007, attorney docket no. 25791.50, filed on Feb. 20, 2001, (23) U.S. provisional patent application Ser. No. 60/262,434, attorney docket no. 25791.51, filed on Jan. 17, 2001, (24) U.S. provisional patent application Ser. No. 60/259,486, attorney docket no. 25791.52, filed on Jan. 3, 2001, (25) U.S. provisional patent application Ser. No. 60/303,740, attorney docket no. 25791.61, filed on Jul. 6, 2001, (26) U.S. provisional patent application Ser. No. 60/313,453, attorney docket no. 25791.59, filed on Aug. 20, 2001, (27) U.S. provisional patent application Ser. No. 60/317,985, attorney docket no. 25791.67, filed on Sep. 6, 2001, (28) U.S. provisional patent application Ser. No. 60/3318,386, attorney docket no. 25791.67.02, filed on Sep. 10, 2001, (29) U.S. utility patent application Ser. No. 09/969,922, attorney docket no. 25791.69, filed on Oct. 3, 2001 (30) U.S. utility patent application Ser. No. 10/016,467, attorney docket no. 25791.70, filed on Dec. 10, 2001, (31) U.S. provisional patent application Ser. No. 60/343,674, attorney docket no. 25791.68, filed on Dec. 27, 2001, (32) U.S. provisional patent application Ser. No. 60/346,309, attorney docket no 25791.92, filed on Jan. 7, 2002, (33) U.S. provisional patent application Ser. No. 60/372,048, attorney docket no. 25791.93, filed on Apr. 12, 2002, (34) U.S. provisional patent application Ser. No. 60/380,147, attorney docket no. 25791.104, filed on May 6, 2002, (35) U.S. provisional patent application Ser. No. 60/387,486, attorney docket no. 25791.107, filed on Jun. 10, 2002, (36) U.S. provisional patent application Ser. No. 60/387,961, attorney docket no. 25791.108, filed on Jun. 12, 2002, (37) U.S. provisional patent application Ser. No. 60/391,703, attorney docket no. 25791.90, filed on Jun. 26, 2002, (38) U.S. provisional patent application Ser. No. 60/397,284, attorney docket no. 25791.106, filed on Jul. 19, 2002, and (39) U.S. provisional patent application Ser. No. 60/398,061, attorney docket no. 25791.110, filed on Jul. 24, 2002, (40) U.S. provisional patent application Ser. No. 60/405,610, attorney docket no. 25791.119, filed on Aug. 23, 2002, and (41) U.S. provisional patent application Ser. No. 60/405,394, attorney docket no. 25791.120, filed on Aug. 23, 2002, the disclosures of which are incorporated herein by reference.

### BACKGROUND OF THE INVENTION

This invention relates generally to oil and gas pipelines, and in particular to manufacturing oil and gas pipelines to facilitate oil and gas exploration and production.

Conventionally, when oil and/or gas is transported from an offshore production facility to another offshore and/or onshore production, processing, and/or transport facility, the oil and/or gas is conveyed through an insulated pipeline positioned on the ocean floor. The insulated pipeline is used in order to minimize cooling of the oil and/or gas by the ocean water. Excessive cooling of the oil and/or gas can cause undesirable side effects, such as, for example, wax formation, that can severely effect the efficiency of the conveyance of the oil and/or gas. The insulated pipeline is manufactured onshore in a conventional manner, rolled up onto a dispensing reel, and then placed onto a ship for transport to the ultimate location of the insulated pipeline. The insulated pipeline is then unreeled off of the dispensing reel on the ship, lowered onto the ocean, and positioned on the ocean floor. The cost of purchasing and positioning the pre-fabricated insulated pipelines for typical offshore production fields can easily exceed the total cost of the production wells themselves.

The present invention is directed to overcoming one or more of the limitations of the existing procedures for transporting oil and/or gas production using insulated pipelines.

### SUMMARY OF THE INVENTION

According to one aspect of the present invention, a method of manufacturing an insulated pipeline has been provided that includes positioning a first pipe having a plurality of spaced apart resilient sleeves coupled to the exterior surface of the first pipe within a second pipe, and radially expanding and plastically deforming the first pipe until the resilient sleeves engage the interior surface of the second pipe.

According to another aspect of the present invention, a system for manufacturing an insulated pipeline is provided that includes means for positioning a first pipe having a plurality of spaced apart resilient sleeves coupled to the exterior surface of the first pipe within a second pipe, and means for radially expanding and plastically deforming the first pipe until the resilient sleeves engage the interior surface of the second pipe.

According to another aspect of the present invention, a method of manufacturing an insulated pipeline that includes an inner rigid pipe positioned within, coupled to, and thermally insulated from an outer rigid pipe is provided that includes manufacturing the insulated pipeline by radially expanding and plastically deforming the inner rigid pipe within the outer rigid pipe.

According to another aspect of the present invention, a system for manufacturing an insulated pipeline including an inner rigid pipe positioned within, coupled to, and thermally insulated from an outer rigid pipe is provided that includes means for manufacturing the insulated pipeline by radially expanding and plastically deforming the inner rigid pipe within the outer rigid pipe.

According to another aspect of the present invention, a thermally insulated pipeline is provided that includes a plastically deformed first pipe, a plurality of spaced apart resilient sleeves coupled to the exterior of the first pipe, and a second pipe coupled to the resilient sleeves.

According to another aspect of the present invention, a method of operating a hydrocarbon production system for processing hydrocarbons that includes one or more hydrocarbon production sources and one or more hydrocarbon production destinations, is provided that includes conveying hydrocarbons between the hydrocarbon production sources and the hydrocarbon destinations using one or more insulated pipelines, and manufacturing at least one of the insulated pipelines by radially expanding and plastically deforming an inner rigid pipe within an outer rigid pipe.

According to another aspect of the present invention, a method of manufacturing an insulated wellbore casing within a borehole that traverses a subterranean formation and includes a first wellbore casing coupled to and positioned within the wellbore is provided that includes positioning a second wellbore casing having a plurality of spaced apart resilient sleeves coupled to the exterior surface of the first pipe within the first wellbore casing, and radially expanding and plastically deforming the second wellbore casing until the resilient sleeves engage the interior surface of the second pipe.

### BRIEF DESCRIPTION OF THE DRAWINGS

FIG. 1 is a fragmentary cross-sectional illustration of a first pipe having a plurality of spaced apart resilient sleeves positioned within a second pipe.

FIG. 2 is a fragmentary cross-sectional illustration of the apparatus of FIG. 1 during the radial expansion and plastic deformation of the first pipe within the second pipe.

FIG. 3 is a fragmentary cross-sectional illustration of the apparatus of FIG. 2 after completing the radial expansion and plastic deformation of the first pipe within the second pipe.

FIG. 4 is a fragmentary cross sectional of the positioning of the apparatus of FIG. 3 beneath the ocean floor.

FIG. 5 is a schematic illustration of the use of the apparatus of FIGS. 3 and/or 4 to convey hydrocarbons between and among hydrocarbon production facilities and hydrocarbon delivery and/or processing facilities.

FIG. 6 is a fragmentary cross sectional illustration of an alternative embodiment of the apparatus of FIG. 1 in which a thermal insulation material is injected into the annulus between the first and second pipes prior to radially expanding and plastically deforming the second pipe.

FIG. 7 is a fragmentary cross-sectional illustration of the apparatus of FIG. 6 during the radial expansion and plastic deformation of the first pipe within the second pipe.

FIG. 8 is a fragmentary cross-sectional illustration of the apparatus of FIG. 7 after completing the radial expansion and plastic deformation of the first pipe within the second pipe.

FIG. 9 is a fragmentary cross sectional illustration of an alternative embodiment of the apparatus of FIG. 3 in which a supply of thermal insulation material is injected into the annulus between the first and second pipes after the radial expansion and plastic deformation of the second pipe.

FIG. 9a is a cross sectional illustration of the apparatus of FIG. 9.

FIG. 10 is a fragmentary cross sectional illustration of the apparatus of FIG. 9 after injecting a thermal insulation material into the annulus between the first and second pipes.

FIG. 11 is a fragmentary cross sectional illustration of an alternative embodiment of the apparatus of FIG. 1 in which tubular sections of insulating material are coupled to the exterior surface of the first pipe between and interleaved among the resilient sleeves.

FIG. 12 is a fragmentary cross-sectional illustration of the apparatus of FIG. 11 during the radial expansion and plastic deformation of the first pipe within the second pipe.

FIG. 13 is a fragmentary cross-sectional illustration of the apparatus of FIG. 12 after completing the radial expansion and plastic deformation of the first pipe within the second pipe.

### DETAILED DESCRIPTION OF THE ILLUSTRATIVE EMBODIMENTS

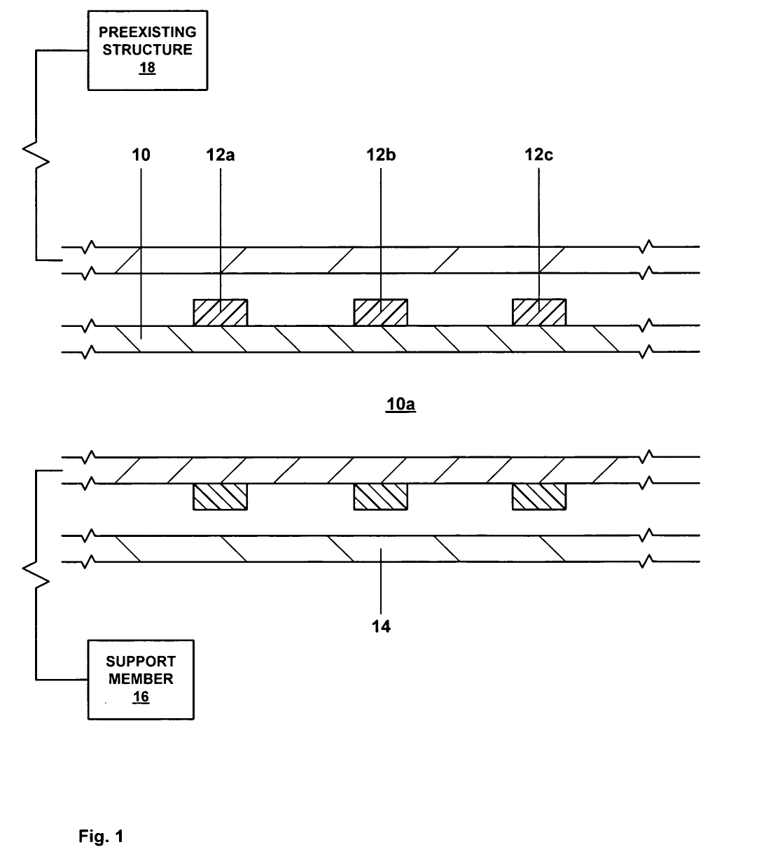

Referring to FIG. 1, a first pipe 10 that defines a passage 10a and includes a plurality of resilient spaced apart sleeves 12 that are coupled to the exterior surface of the first pipe is positioned within a second pipe 14. In several exemplary embodiments, the first and second pipes, 10 and 14, are metallic and may each include a plurality of pipes threadably coupled together end to end, and the sleeves 12 are metallic and/or rubber and/or ceramic and/or composite. In an exemplary embodiment, the thermal conductivity of the sleeves 12 is less than the thermal conductivity of the second pipe 14 in order to reduce the transmission of thermal energy from the first pipe 10 to the second pipe after the first pipe is radially expanded and plastically deformed. In an exemplary embodiment, the first pipe 10 is supported within the second pipe 12 by a conventional support member 16, and the second pipe 14 is maintained in a substantially stationary position by coupling the second pipe to a preexisting structure 18 in a conventional manner. In several exemplary embodiments, the preexisting structure 18 may, for example, be a subterranean formation, the surface of the earth, a wellbore, another pipeline, a conventional pipe fixturing device, and/or a conventional pipe support member.

In several exemplary embodiments, the first pipe 10 may, for example, be assembled and/or the first pipe may, for example, be positioned and supported within the second pipe 14 using one or more of the methods and apparatus disclosed in one or more of the following: (1) U.S. patent application Ser. No. 09/454,139, attorney docket no. 25791.03.02, filed on Dec. 3, 1999, (2) U.S. patent application Ser. No. 09/510,913, attorney docket no. 25791.7.02, filed on Feb. 23, 2000, (3) U.S. patent application Ser. No. 09/502,350, attorney docket no. 25791.8.02, filed on Feb. 10, 2000, (4) U.S. Pat. No. 6,328,113, (5) U.S. patent application Ser. No. 09/523,460, attorney docket no. 25791.11.02, filed on Mar. 10, 2000, (6) U.S. patent application Ser. No. 09/512,895, attorney docket no. 25791.12.02, filed on Feb. 24, 2000, (7) U.S. patent application Ser. No. 09/511,941, attorney docket no. 25791.16.02, filed on Feb. 24, 2000, (8) U.S. patent application Ser. No. 09/588,946, attorney docket no. 25791.17.02, filed on Jun. 7, 2000, (9) U.S. patent application Ser. No. 09/559,122, attorney docket no. 25791.23.02, filed on Apr. 26, 2000, (10) PCT patent application Ser. No. PCT/US00/18635, attorney docket no. 25791.25.02, filed on Jul. 9, 2000, (11) U.S. provisional patent application Ser. No. 60/162,671, attorney docket no. 25791.27, filed on Nov. 1, 1999, (12) U.S. provisional patent application Ser. No. 60/154,047, attorney docket no. 25791.29, filed on Sep. 16, 1999, (13) U.S. provisional patent application Ser. No. 60/159,082, attorney docket no. 25791.34, filed on Oct. 12, 1999, (14) U.S. provisional patent application Ser. No. 60/159,039, attorney docket no. 25791.36, filed on Oct. 12, 1999, (15) U.S. provisional patent application Ser. No. 60/159,033, attorney docket no. 25791.37, filed on Oct. 12, 1999, (16) U.S. provisional patent application Ser. No. 60/212,359, attorney docket no. 25791.38, filed on Jun. 19, 2000, (17) U.S. provisional patent application Ser. No. 60/165,228, attorney docket no. 25791.39, filed on Nov. 12, 1999, (18) U.S. provisional patent application Ser. No. 60/221,443, attorney docket no. 25791.45, filed on Jul. 28, 2000, (19) U.S. provisional patent application Ser. No. 60/221,645, attorney docket no. 25791.46, filed on Jul. 28, 2000, (20) U.S. provisional patent application Ser. No. 60/233,638, attorney docket no. 25791.47, filed on Sep. 18, 2000, (21) U.S. provisional patent application Ser. No. 60/237,334, attorney docket no. 25791.48, filed on Oct. 2, 2000, (22) U.S. provisional patent application Ser. No. 60/270,007, attorney docket no. 25791.50, filed on Feb. 20, 2001, (23) U.S. provisional patent application Ser. No. 60/262,434, attorney docket no. 25791.51, filed on Jan. 17, 2001, (24) U.S. provisional patent application Ser. No. 60/259,486, attorney docket no. 25791.52, filed on Jan. 3, 2001, (25) U.S. provisional patent application Ser. No. 60/303,740, attorney docket no. 25791.61, filed on Jul. 6, 2001, (26) U.S. provisional patent application Ser. No. 60/313,453, attorney docket no. 25791.59, filed on Aug. 20, 2001, (27) U.S. provisional patent application Ser. No. 60/317,985, attorney docket no. 25791.67, filed on Sep. 6, 2001, (28) U.S. provisional patent application Ser. No. 60/3318,386, attorney docket no. 25791.67.02, filed on Sep. 10, 2001, (29) U.S. utility patent application Ser. No. 09/969,922, attorney docket no. 25791.69, filed on Oct. 3, 2001, (30) U.S. utility patent application Ser. No. 10/016,467, attorney docket no. 25791.70, filed on Dec. 10, 2001, (31) U.S. provisional patent application Ser. No. 60/343,674, attorney docket no. 25791.68, filed on Dec. 27, 2001, (32) U.S. provisional patent application Ser. No. 60/346,309, attorney docket no 25791.92, filed on Jan. 7, 2002, (33) U.S. provisional patent application Ser. No. 60/372,048, attorney docket no. 25791.93, filed on Apr. 12, 2002, (34) U.S. provisional patent application Ser. No. 60/380,147, attorney docket no. 25791.104, filed on May 6, 2002, (35) U.S. provisional patent application Ser. No. 60/387,486, attorney docket no. 25791.107, filed on Jun. 10, 2002, (36) U.S. provisional patent application Ser. No. 60/387,961, attorney docket no. 25791.108, filed on Jun. 12, 2002, (37) U.S. provisional patent application Ser. No. 60/391,703, attorney docket no. 25791.90, filed on Jun. 26, 2002, (38) U.S. provisional patent application Ser. No. 60/397,284, attorney docket no. 25791.106, filed on Jul. 19, 2002, and (39) U.S. provisional patent application Ser. No. 60/398,061, attorney docket no. 25791.110, filed on Jul. 24, 2002, (40) U.S. provisional patent application Ser. No. 60/405,610, attorney docket no. 25791.119, filed on Aug. 23, 2002, and (41) U.S. provisional patent application Ser. No. 60/405,394, attorney docket no. 25791.120, filed on Aug. 23, 2002, the disclosures of which are incorporated herein by reference.

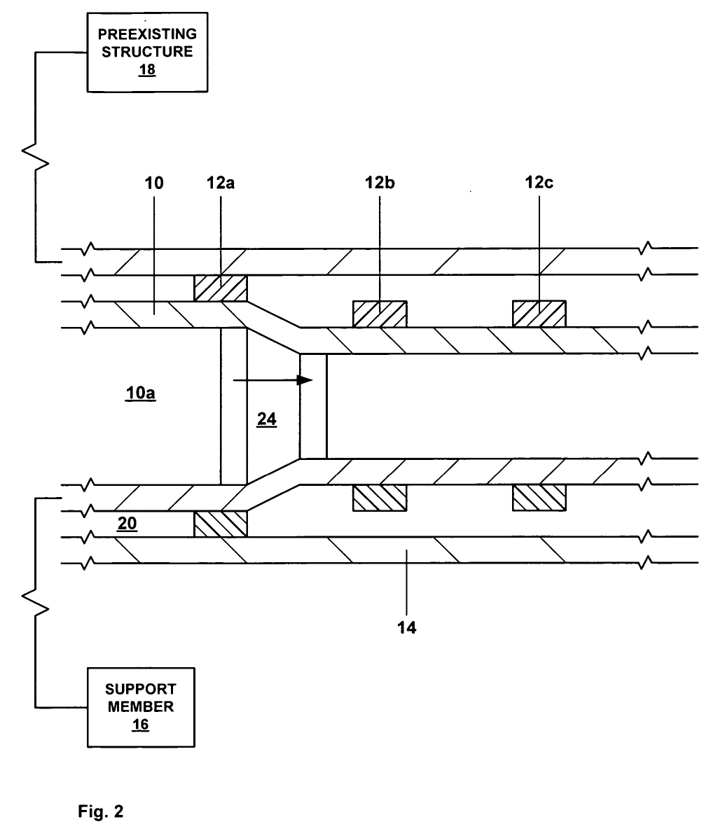

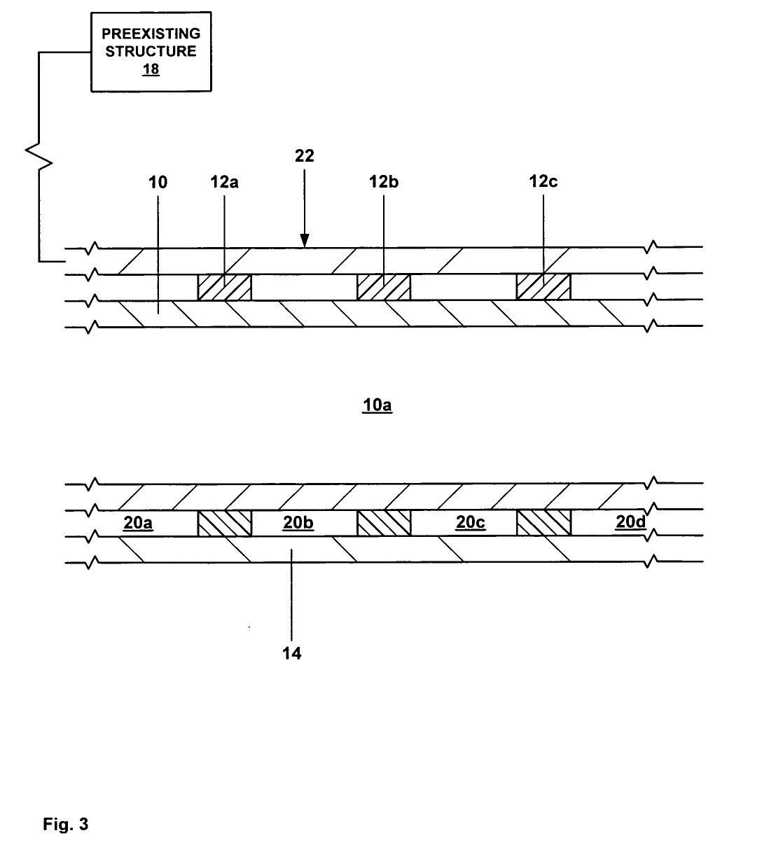

Referring to FIGS. 2 and 3, the first pipe 10 is then radially expanded and plastically deformed within the second pipe 14 until the sleeves 12 engage and thereby support the first pipe within the second pipe in a spaced apart relationship. In this manner, an annulus 20 is maintained between the first and second pipes, 10 and 14. After completing the radial expansion and plastic deformation of the first pipe 10 within the second pipe 14, the first pipe is decoupled from the support member 16. As a result, a thermally insulated pipeline 22 is manufactured that includes the radially expanded and plastically deformed first pipe 10 positioned within and coupled to the second pipe 14, the spaced apart resilient sleeves 12 that support the first pipe within the second pipe, and a plurality of tubular air gaps 20 positioned between and interleaved among the resilient sleeves. In an exemplary embodiment, the thermal conductivities of the resilient sleeves 12 and the air gaps 20 are both less than the thermal conductivities of the first and second pipes, 10 and 14, in order to reduce the transmission of thermal energy between the first and second pipes.

In several exemplary embodiments, the first pipe 10 is radially expanded and plastically deformed within the second pipe 14 by displacing an expansion cone 24 within the first pipe using one or more of the methods and apparatus disclosed in one or more of the following: (1) U.S. patent application Ser. No. 09/454,139, attorney docket no. 25791.03.02, filed on Dec. 3, 1999, (2) U.S. patent application Ser. No. 09/510,913, attorney docket no. 25791.7.02, filed on Feb. 23, 2000, (3) U.S. patent application Ser. No. 09/502,350, attorney docket no. 25791.8.02, filed on Feb. 10, 2000, (4) U.S. Pat. No. 6,328,113, (5) U.S. patent application Ser. No. 09/523,460, attorney docket no. 25791.11.02, filed on Mar. 10, 2000, (6) U.S. patent application Ser. No. 09/512,895, attorney docket no. 25791.12.02, filed on Feb. 24, 2000, (7) U.S. patent application Ser. No. 09/511,941, attorney docket no. 25791.16.02, filed on Feb. 24, 2000, (8) U.S. patent application Ser. No. 09/588,946, attorney docket no. 25791.17.02, filed on Jun. 7, 2000, (9) U.S. patent application Ser. No. 09/559,122, attorney docket no. 25791.23.02, filed on Apr. 26, 2000, (10) PCT patent application Ser. No. PCT/US00/18635, attorney docket no. 25791.25.02, filed on Jul. 9, 2000, (11) U.S. provisional patent application Ser. No. 60/162,671, attorney docket no. 25791.27, filed on Nov. 1, 1999, (12) U.S. provisional patent application Ser. No. 60/154,047, attorney docket no. 25791.29, filed on Sep. 16, 1999, (13) U.S. provisional patent application Ser. No. 60/159,082, attorney docket no. 25791.34, filed on Oct. 12, 1999, (14) U.S. provisional patent application Ser. No. 60/159,039, attorney docket no. 25791.36, filed on Dec. 12, 1999, (15) U.S. provisional patent application Ser. No. 60/159,033, attorney docket no. 25791.37, filed on Oct. 12, 1999, (16) U.S. provisional patent application Ser. No. 60/212,359, attorney docket no. 25791.38, filed on Jun. 19, 2000, (17) U.S. provisional patent application Ser. No. 60/165,228, attorney docket no. 25791.39, filed on Nov. 12, 1999, (18) U.S. provisional patent application Ser. No. 60/221,443, attorney docket no. 25791.45, filed on Jul. 28, 2000, (19) U.S. provisional patent application Ser. No. 60/221,645, attorney docket no. 25791.46, filed on Jul. 28, 2000, (20) U.S. provisional patent application Ser. No. 60/233,638, attorney docket no. 25791.47, filed on Sep. 18, 2000, (21) U.S. provisional patent application Ser. No. 60/237,334, attorney docket no. 25791.48, filed on Oct. 2, 2000, (22) U.S. provisional patent application Ser. No. 60/270,007, attorney docket no. 25791.50, filed on Feb. 20, 2001, (23) U.S. provisional patent application Ser. No. 60/262,434, attorney docket no. 25791.51, filed on Jan. 17, 2001, (24) U.S. provisional patent application Ser. No. 60/259,486, attorney docket no. 25791.52, filed on Jan. 3, 2001, (25) U.S. provisional patent application Ser. No. 60/303,740, attorney docket no. 25791.61, filed on Jul. 6, 2001, (26) U.S. provisional patent application Ser. No. 60/313,453, attorney docket no. 25791.59, filed on Aug. 20, 2001, (27) U.S. provisional patent application Ser. No. 60/317,985, attorney docket no. 25791.67, filed on Sep. 6, 2001, (28) U.S. provisional patent application Ser. No. 60/3318,386, attorney docket no. 25791.67.02, filed on Sep. 10, 2001, (29) U.S. utility patent application Ser. No. 09/969,922, attorney docket no. 25791.69, filed on Oct. 3, 2001, (30) U.S. utility patent application Ser. No. 10/016,467, attorney docket no. 25791.70, filed on Dec. 10, 2001, (31) U.S. provisional patent application Ser. No. 60/343,674, attorney docket no. 25791.68, filed on Dec. 27, 2001, (32) U.S. provisional patent application Ser. No. 60/346,309, attorney docket no 25791.92, filed on Jan. 7, 2002, (33) U.S. provisional patent application Ser. No. 60/372,048, attorney docket no. 25791.93, filed on Apr. 12, 2002, (34) U.S. provisional patent application Ser. No. 60/380,147, attorney docket no. 25791.104, filed on May 6, 2002, (35) U.S. provisional patent application Ser. No. 60/387,486, attorney docket no. 25791.107, filed on Jun. 10, 2002, (36) U.S. provisional patent application Ser. No. 60/387,961, attorney docket no. 25791.108, filed on Jun. 12, 2002, (37) U.S. provisional patent application Ser. No. 60/391,703, attorney docket no. 25791.90, filed on Jun. 26, 2002, (38) U.S. provisional patent application Ser. No. 60/397,284, attorney docket no. 25791.106, filed on Jul. 19, 2002, and (39) U.S. provisional patent application Ser. No. 60/398,061, attorney docket no. 25791.110, filed on Jul. 24, 2002, (40) U.S. provisional patent application Ser. No. 60/405,610, attorney docket no. 25791.119, filed on Aug. 23, 2002, and (41) U.S. provisional patent application Ser. No. 60/405,394, attorney docket no. 25791.120, filed on Aug. 23, 2002, the disclosures of which are incorporated herein by reference.

In several alternative embodiments, the first pipe 10 may be radially expanded and plastically deformed within the second pipe 14 using other conventional methods such as, for example, such as, for example, internal pressurization and/or roller expansion devices such as, for example, that disclosed in U.S. patent application publication nos. U.S. 2001/0045284 A1, U.S. 2002/0108756 A1, U.S. 2003/0047323 A1, and U.S. 2003/0047320 A1, U.S. Pat. Nos. 6,012,523, 6,112,818, and 6,578,630, and/or International Publication Nos. WO 03/055616 A2, WO 03/048521 A2, WO 03/048520 A2, the disclosures of which are incorporated herein by reference, and/or, for example, any of the expansion methods and apparatus commercially available from Enventure Global Technology L.L.C., Weatherford International and/or Baker Oil Tools.

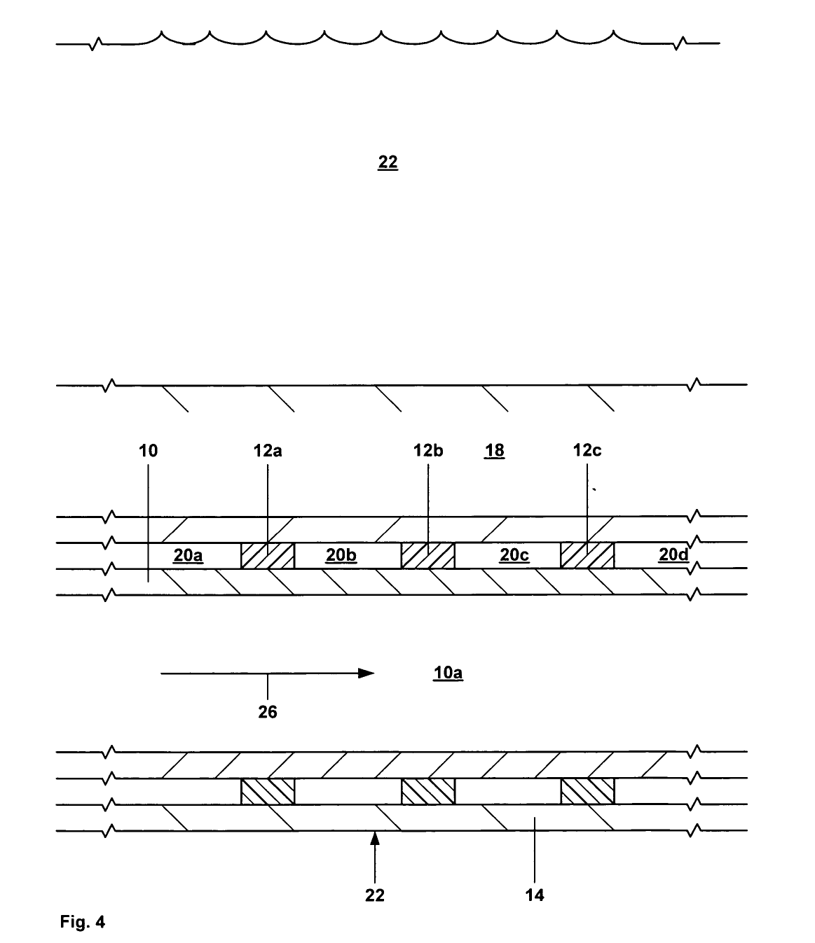

Referring to FIG. 4, in an exemplary embodiment, the preexisting structure 18 is a subterranean formation positioned beneath a body of water 22 such as, for example, an ocean, bay, river, lake or other body of water. In this manner, fluidic materials 26 may be conveyed through the passage 10a of the first pipe 10 of the insulated pipeline 22 through the subterranean formation 18 below the body of water 22. In several exemplary embodiments, the fluidic materials 26, may, for example, include oil, gas, and/or other hydrocarbon materials. In several exemplary embodiments, one or more of the operational procedures illustrated and described above with reference to FIGS. 1-3 are performed while the first and second pipes, 10 and 14, are both positioned within the subterranean formation 18. In this manner, the insulated pipeline 22 may be manufactured at least partially in situ by radially expanding the first pipe 10 which provides a much more cost efficient method of manufacturing an insulated pipeline.

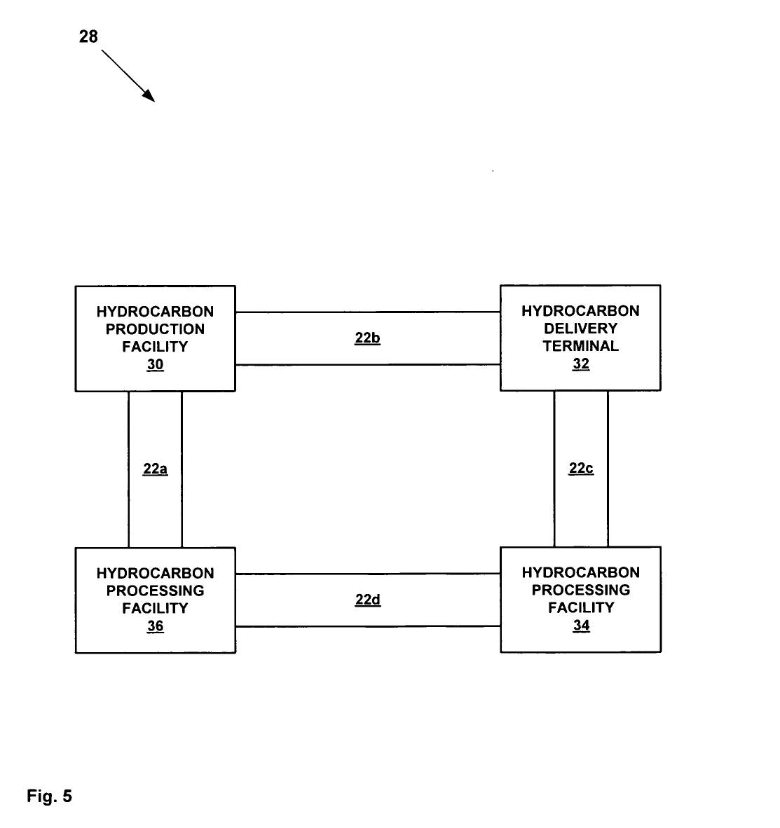

Referring to FIG. 5, a hydrocarbon production system 28 includes insulated pipelines 22a, 22b, 22c, and 22d, for conveying hydrocarbon materials between and among a hydrocarbon production facility 30, a hydrocarbon delivery terminal 32, a hydrocarbon processing facility 34, and a hydrocarbon processing facility 36. In an exemplary embodiment, the hydrocarbon production facility 30 may include one or more offshore and/or onshore production wells, the hydrocarbon delivery terminal 32 may include one or more offshore and/or onshore delivery and/or storage terminals, and the hydrocarbon processing facilities, 34 and 36, may include one or more processing plants for processing hydrocarbon materials to generate refined and/or reformulated hydrocarbon materials. In an exemplary embodiment, the use of the insulated pipelines 22 in the system 28 provides a number of important benefits. For example, the insulated pipelines 22 reduce the loss of thermal energy from the hydrocarbon materials during transmission thereby reducing the unwanted formation of waxes. Furthermore, the insulated pipelines 22 also permit the material properties of the hydrocarbon products to be more precisely controlled during transmission thereby enhancing the overall operational efficiency of the system 28. Finally, because the insulated pipelines can be manufactured in situ, by expanding the first pipe 10 into engagement with the second pipe 14, the cost of providing the insulated pipelines 22 to the system 28 is significantly less than using conventional pre-fabricated insulated pipelines.

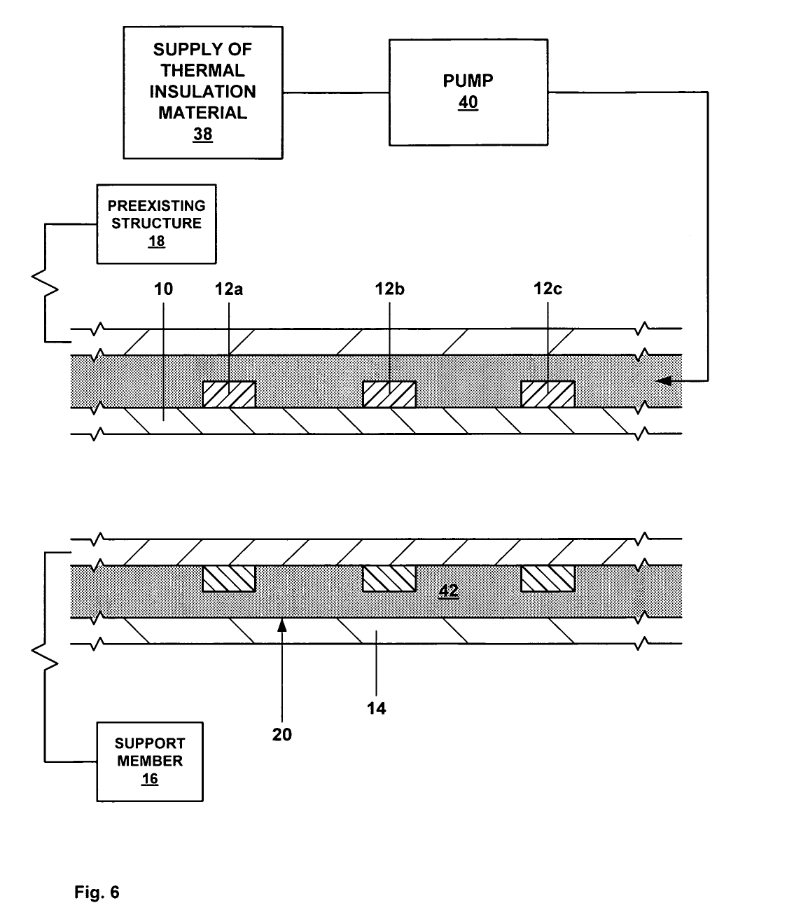

Referring to FIG. 6, in an alternative embodiment of the apparatus of FIG. 1, a supply of thermal insulation material 38 is operably coupled to a pump 40 that in turn is operably coupled to the annulus 20 between the first pipe 10 and the second pipe 14. Thermal insulation material 42 is then injected into the annulus 20 between the first and second pipes, 10 and 14, by operating the pump 40. The thermal insulating material 42 may be any conventional injectable insulation material that may or may not expand volumetrically or chemically react after being injected into the annulus 20 by the pump 40. In an exemplary embodiment, the thermal conductivity of the thermal insulating material 42 is less than the thermal conductivities of both the first and second pipes, 10 and 14.

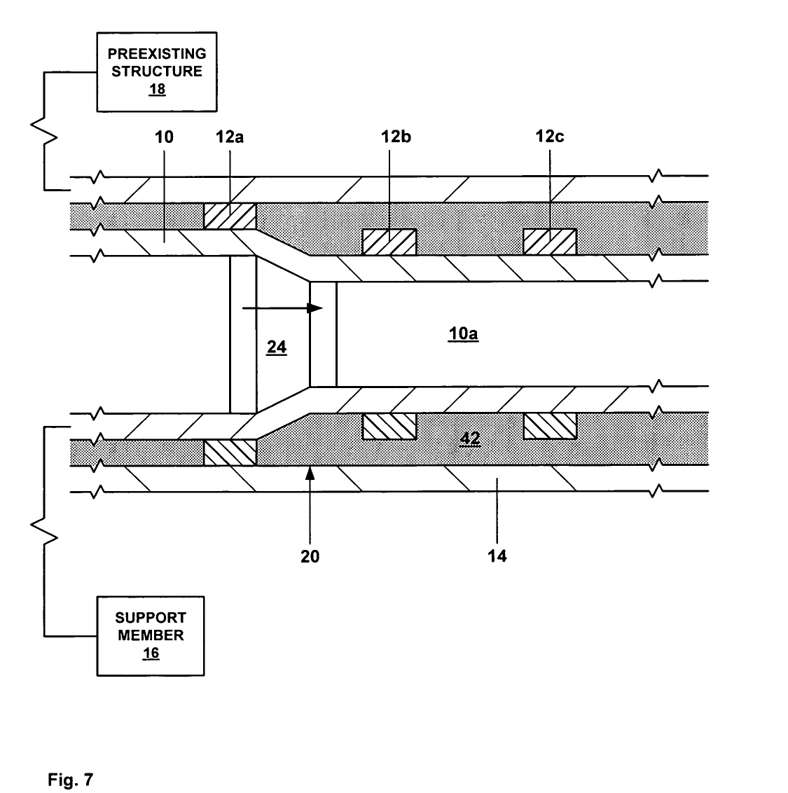

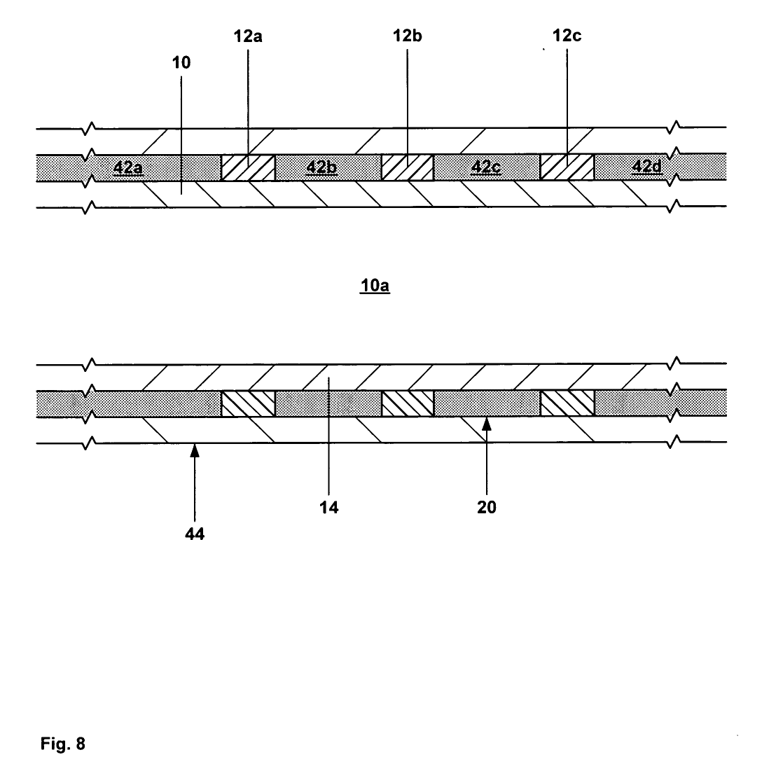

Referring to FIGS. 7 and 8, the first pipe 10 is then radially expanded and plastically deformed within the second pipe 14 until the sleeves 12 engage and thereby support the first pipe within the second pipe in a spaced apart relationship. After completing the radial expansion and plastic deformation of the first pipe 10 within the second pipe 14, the first pipe is decoupled from the support member 16. As a result, a thermally insulated pipe 44 is manufactured that includes the radially expanded and plastically deformed first pipe 10 positioned within and coupled to the second pipe 14, the spaced apart resilient sleeves 12 that support the first pipe within the second pipe, and a plurality of thermal insulating sleeves 42 positioned between and interleaved among the resilient sleeve 12.

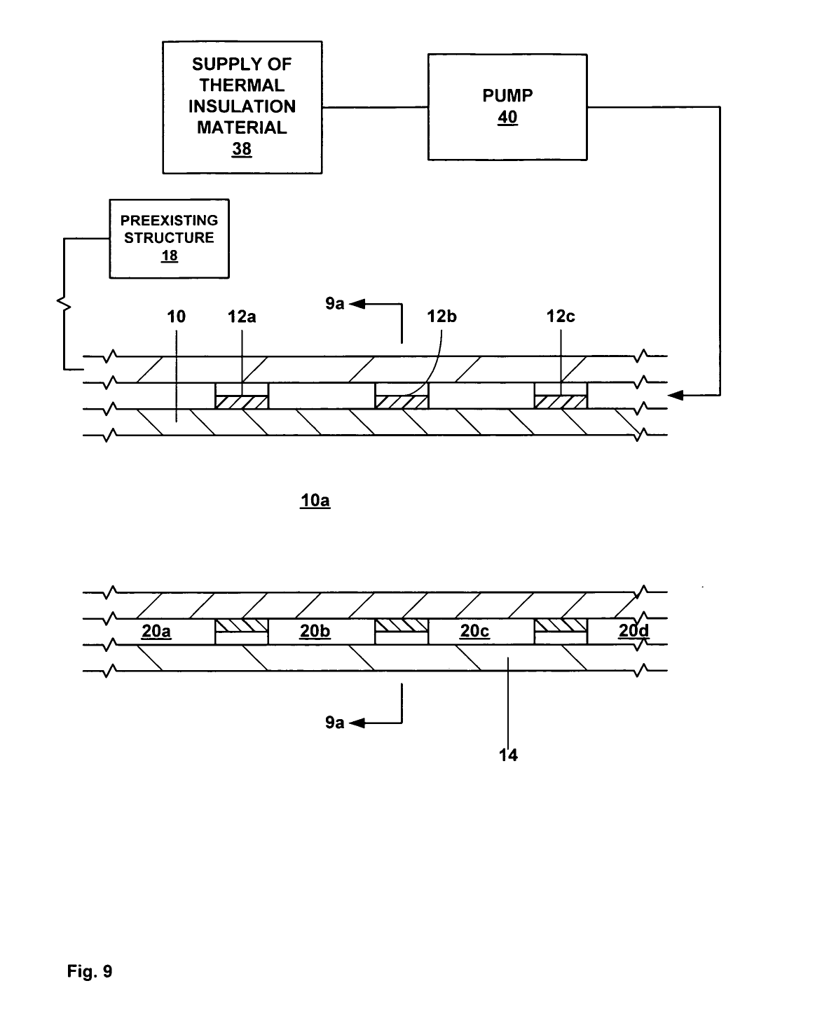

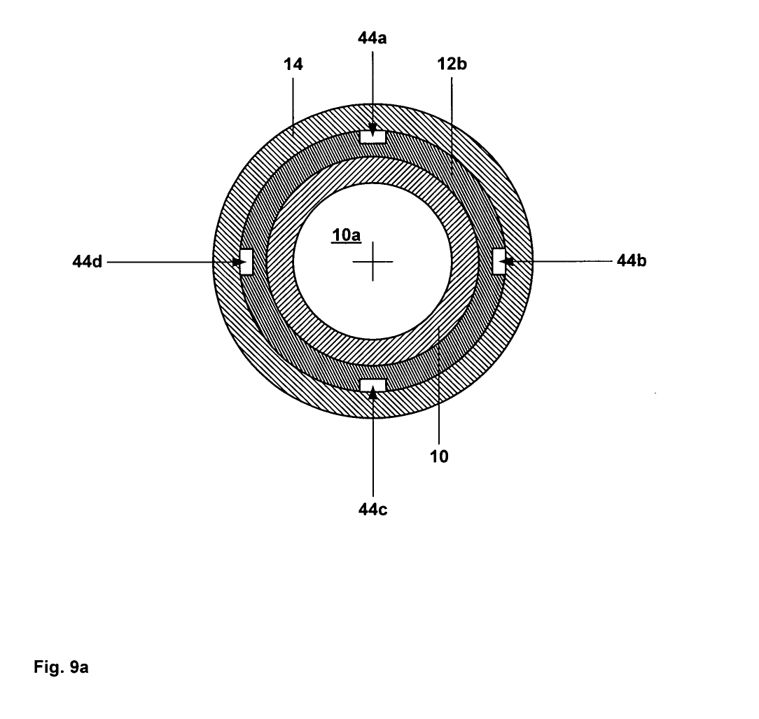

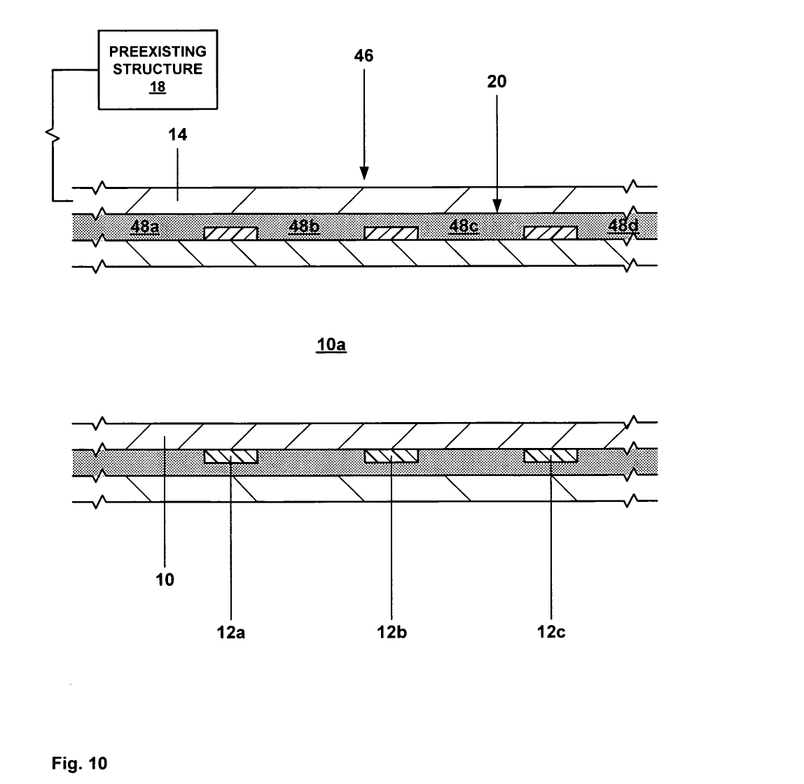

Referring to FIGS. 9, 9a, and 10, in an alternative embodiment of the apparatus of FIG. 3, one or more of the resilient sleeves 12 include one or more longitudinal passages 44 that permit thermal insulation material 42 to be injected through the longitudinal passages and into the tubular air gaps 20 between the resilient sleeves 12. As a result, a thermally insulated pipe 46 is manufactured that includes the radially expanded and plastically deformed first pipe 10 positioned within and coupled to the second pipe 14, the spaced apart resilient sleeves 12 that support the first pipe within the second pipe, and a plurality of thermal insulating sleeves 48 positioned between and interleaved among the resilient sleeve 12. In an exemplary embodiment, the thermal conductivities of the thermal insulating sleeves 48 are less than the thermal conductivities of both the first and second pipes, 10 and 14.

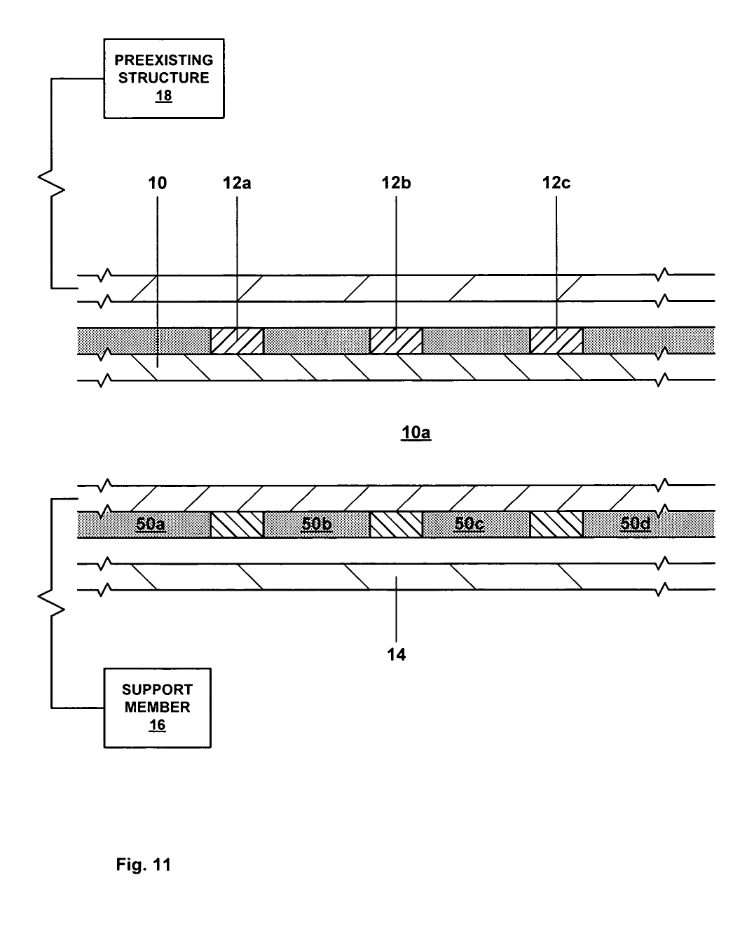

Referring to FIG. 11, in an alternative embodiment of the apparatus of FIG. 1, a plurality of tubular thermal insulating members 50 are coupled to the exterior surface of the first pipe 10 between and interleaved among the spaced apart resilient sleeves 12. The thermal insulating members 50 may be composed of any number of conventional thermal insulating materials. In an exemplary embodiment, the thermal conductivities of the thermal insulating members 50 are less than the thermal conductivities of both the first and second pipes, 10 and 14.

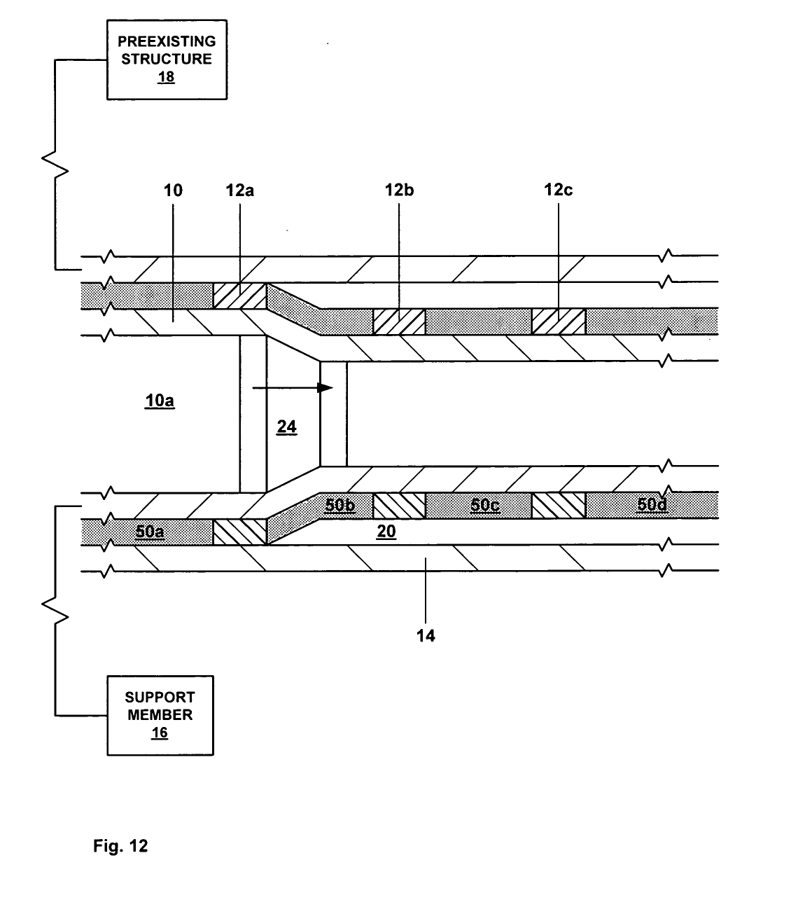

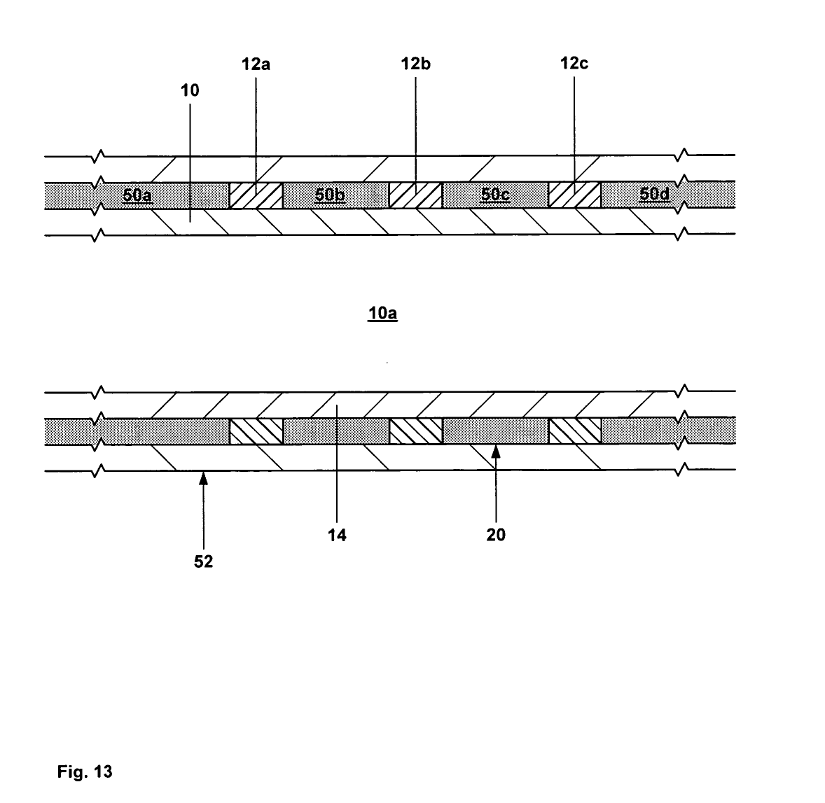

Referring to FIGS. 12 and 13, the first pipe 10 is then radially expanded and plastically deformed within the second pipe 14 until the sleeves 12 engage and thereby support the first pipe within the second pipe in a spaced apart relationship. After completing the radial expansion and plastic deformation of the first pipe 10 within the second pipe 14, the first pipe is decoupled from the support member 16. As a result, a thermally insulated pipe 52 is manufactured that includes the radially expanded and plastically deformed first pipe 10 positioned within and coupled to the second pipe 14, the spaced apart resilient sleeves 12 that support the first pipe within the second pipe, and the plurality of thermal insulating sleeves 50 positioned between and interleaved among the resilient sleeve 12.

A method of manufacturing an insulated pipeline has been described that includes positioning a first pipe having a plurality of spaced apart resilient sleeves coupled to the exterior surface of the first pipe within a second pipe, and radially expanding and plastically deforming the first pipe until the resilient sleeves engage the interior surface of the second pipe. In an exemplary embodiment, the method further includes injecting an insulating material into an annulus defined between the first and second pipes. In an exemplary embodiment, injecting the insulating material into the annulus defined between the first and second pipes includes injecting the insulating material into the annulus defined between the first and second pipes before radially expanding and plastically deforming the first pipe. In an exemplary embodiment, injecting the insulating material into the annulus defined between the first and second pipes includes injecting the insulating material into the annulus defined between the first and second pipes after radially expanding and plastically deforming the first pipe. In an exemplary embodiment, the first pipe further includes a plurality of thermal insulating sleeves coupled to the exterior surface of the first pipe and interleaved among the resilient sleeves. In an exemplary embodiment, positioning the first pipe having the plurality of spaced apart resilient sleeves coupled to the exterior surface of the first pipe within the second pipe includes positioning the second pipe beneath a body of water, and positioning the first pipe having the plurality of spaced apart resilient sleeves coupled to the exterior surface of the first pipe within the second pipe.

A system for manufacturing an insulated pipeline has also been described that includes means for positioning a first pipe having a plurality of spaced apart resilient sleeves coupled to the exterior surface of the first pipe within a second pipe, and means for radially expanding and plastically deforming the first pipe until the resilient sleeves engage the interior surface of the second pipe. In an exemplary embodiment, the system further includes means for injecting an insulating material into an annulus defined between the first and second pipes. In an exemplary embodiment, the means for injecting the insulating material into the annulus defined between the first and second pipes includes means for injecting the insulating material into the annulus defined between the first and second pipes before radially expanding and plastically deforming the first pipe. In an exemplary embodiment, the means for injecting the insulating material into the annulus defined between the first and second pipes includes means for injecting the insulating material into the annulus defined between the first and second pipes after radially expanding and plastically deforming the first pipe. In an exemplary embodiment, the first pipe further includes a plurality of thermal insulating sleeves coupled to the exterior surface of the first pipe and interleaved among the resilient sleeves. In an exemplary embodiment, the means for positioning the first pipe having the plurality of spaced apart resilient sleeves coupled to the exterior surface of the first pipe within the second pipe includes means for positioning the second pipe beneath a body of water, and means for positioning the first pipe having the plurality of spaced apart resilient sleeves coupled to the exterior surface of the first pipe within the second pipe.

A method of manufacturing an insulated pipeline comprising an inner rigid pipe positioned within, coupled to, and thermally insulated from an outer rigid pipe, has been described that includes manufacturing the insulated pipeline by radially expanding and plastically deforming the inner rigid pipe within the outer rigid pipe. In an exemplary embodiment, the method further includes positioning the outer rigid pipe at a location at which the insulated pipeline will be used to convey fluidic materials through the interior of the first pipe, and manufacturing the insulated pipeline by radially expanding and plastically deforming the inner rigid pipe within the outer rigid pipe while the inner and outer rigid pipes are both positioned at the location at which the insulated pipeline will be used to convey fluidic materials through the interior of the first pipe. In an exemplary embodiment, the location at which the insulated pipeline will be used to convey fluidic materials through the interior of the first pipe is below a body of water.

A system for manufacturing an insulated pipeline comprising an inner rigid pipe positioned within, coupled to, and thermally insulated from an outer rigid pipe, has been described that includes means for manufacturing the insulated pipeline by radially expanding and plastically deforming the inner rigid pipe within the outer rigid pipe. In an exemplary embodiment, the system further includes means for positioning the outer rigid pipe at a location at which the insulated pipeline will be used to convey fluidic materials through the interior of the first pipe, and means for manufacturing the insulated pipeline by radially expanding and plastically deforming the inner rigid pipe within the outer rigid pipe while the inner and outer rigid pipes are both positioned at the location at which the insulated pipeline will be used to convey fluidic materials through the interior of the first pipe. In an exemplary embodiment, the location at which the insulated pipeline will be used to convey fluidic materials through the interior of the first pipe is below a body of water.

A thermally insulated pipeline has been described that includes a plastically deformed first pipe, a plurality of spaced apart resilient sleeves coupled to the exterior of the first pipe, and a second pipe coupled to the resilient sleeves. In an exemplary embodiment, the insulated pipeline further includes thermal insulating material positioned within an annulus defined between the first and second pipes and interleaved among the resilient sleeves. In an exemplary embodiment, one or more of the resilient sleeves include one or more longitudinal passages. In an exemplary embodiment, at least some of the thermal insulating material is positioned within the longitudinal passages.

A method of operating a hydrocarbon production system for processing hydrocarbons that includes one or more hydrocarbon production sources and one or more hydrocarbon production destinations has been described that includes conveying hydrocarbons between the hydrocarbon production sources and the hydrocarbon destinations using one or more insulated pipelines, and manufacturing at least one of the insulated pipelines by radially expanding and plastically deforming an inner rigid pipe within an outer rigid pipe. In an exemplary embodiment, the method further includes positioning the outer rigid pipe at a location at which the at least one insulated pipeline will be used to convey fluidic materials through the interior of the first pipe, and manufacturing the at least one insulated pipeline by radially expanding and plastically deforming the inner rigid pipe within the outer rigid pipe while the inner and outer rigid pipes are both positioned at the location at which the at least one insulated pipeline will be used to convey fluidic materials through the interior of the first pipe. In an exemplary embodiment, the location at which the at least one insulated pipeline will be used to convey fluidic materials through the interior of the first pipe is below a body of water.

A method of manufacturing an insulated wellbore casing within a borehole that traverses a subterranean formation and includes a first wellbore casing coupled to and positioned within the wellbore has been described that includes positioning a second wellbore casing having a plurality of spaced apart resilient sleeves coupled to the exterior surface of the first pipe within the first wellbore casing, and radially expanding and plastically deforming the second wellbore casing until the resilient sleeves engage the interior surface of the second pipe. In an exemplary embodiment, the method further includes injecting an insulating material into an annulus defined between the first and second wellbore casings. In an exemplary embodiment, injecting the insulating material into the annulus defined between the first and second wellbore casings includes injecting the insulating material into the annulus defined between the first and second wellbore casings before radially expanding and plastically deforming the first pipe. In an exemplary embodiment, injecting the insulating material into the annulus defined between the first and second wellbore casings includes injecting the insulating material into the annulus defined between the first and second wellbore casings after radially expanding and plastically deforming the second wellbore casing. In an exemplary embodiment, the second wellbore casing further includes a plurality of thermal insulating sleeves coupled to the exterior surface of the second wellbore casing and interleaved among the resilient sleeves.

It is understood that variations may be made in the foregoing without departing from the scope of the invention. For example, the teachings of the present illustrative embodiments may be used to provide an insulated wellbore casing, a pipeline, or a structural support. Furthermore, the elements and teachings of the various illustrative embodiments may be combined in whole or in part in some or all of the illustrative embodiments.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A method of manufacturing an insulated pipeline, comprising:
positioning a first pipe having a plurality of spaced apart resilient sleeves coupled to the exterior surface of the first pipe within a second pipe; and
radially expanding and plastically deforming the first pipe until the resilient sleeves engage the interior surface of the second pipe.

2. The method of claim 1, further comprising:
injecting an insulating material into an annulus defined between the first and second pipes.

3. The method of claim 2, wherein injecting the insulating material into the annulus defined between the first and second pipes comprises:
injecting the insulating material into the annulus defined between the first and second pipes before radially expanding and plastically deforming the first pipe.

4. The method of claim 2, wherein injecting the insulating material into the annulus defined between the first and second pipes comprises:
injecting the insulating material into the annulus defined between the first and second pipes after radially expanding and plastically deforming the first pipe.

5. The method of claim 1, wherein the first pipe further comprises:
a plurality of thermal insulating sleeves coupled to the exterior surface of the first pipe and interleaved among the resilient sleeves.

6. The method of claim 1, wherein positioning the first pipe having the plurality of spaced apart resilient sleeves coupled to the exterior surface of the first pipe within the second pipe comprises:
positioning the second pipe beneath a body of water; and
positioning the first pipe having the plurality of spaced apart resilient sleeves coupled to the exterior surface of the first pipe within the second pipe.

7. A system for manufacturing an insulated pipeline, comprising:
means for positioning a first pipe having a plurality of spaced apart resilient sleeves coupled to the exterior surface of the first pipe within a second pipe; and
means for radially expanding and plastically deforming the first pipe until the resilient sleeves engage the interior surface of the second pipe.

8. The system of claim 7, further comprising:
means for injecting an insulating material into an annulus defined between the first and second pipes.

9. The system of claim 8, wherein means for injecting the insulating material into the annulus defined between the first and second pipes comprises:
means for injecting the insulating material into the annulus defined between the first and second pipes before radially expanding and plastically deforming the first pipe.

10. The system of claim 8, wherein means for injecting the insulating material into the annulus defined between the first and second pipes comprises:
means for injecting the insulating material into the annulus defined between the first and second pipes after radially expanding and plastically deforming the first pipe.

11. The system of claim 7, wherein the first pipe further comprises:
a plurality of thermal insulating sleeves coupled to the exterior surface of the first pipe and interleaved among the resilient sleeves.

12. The system of claim 7, wherein means for positioning the first pipe having the plurality of spaced apart resilient sleeves coupled to the exterior surface of the first pipe within the second pipe comprises:
means for positioning the second pipe beneath a body of water; and
means for positioning the first pipe having the plurality of spaced apart resilient sleeves coupled to the exterior surface of the first pipe within the second pipe.

13. A method of manufacturing an insulated pipeline comprising an inner rigid pipe positioned within, coupled to, and thermally insulated from an outer rigid pipe, comprising:
manufacturing the insulated pipeline by radially expanding and plastically deforming the inner rigid pipe within the outer rigid pipe.

14. The method of claim 13, further comprising:
positioning the outer rigid pipe at a location at which the insulated pipeline will be used to convey fluidic materials through the interior of the first pipe; and
manufacturing the insulated pipeline by radially expanding and plastically deforming the inner rigid pipe within the outer rigid pipe while the inner and outer rigid pipes are both positioned at the location at which the insulated pipeline will be used to convey fluidic materials through the interior of the first pipe.

15. The method of claim 14, wherein the location at which the insulated pipeline will be used to convey fluidic materials through the interior of the first pipe is below a body of water.

16. A system for manufacturing an insulated pipeline comprising an inner rigid pipe positioned within, coupled to, and thermally insulated from an outer rigid pipe, comprising: means for manufacturing the insulated pipeline by radially expanding and plastically deforming the inner rigid pipe within the outer rigid pipe.

17. The system of claim 16, further comprising:
means for positioning the outer rigid pipe at a location at which the insulated pipeline will be used to convey fluidic materials through the interior of the first pipe; and
means for manufacturing the insulated pipeline by radially expanding and plastically deforming the inner rigid pipe within the outer rigid pipe while the inner and outer rigid pipes are both positioned at the location at which the insulated pipeline will be used to convey fluidic materials through the interior of the first pipe.

18. The system of claim 17, wherein the location at which the insulated pipeline will be used to convey fluidic materials through the interior of the first pipe is below a body of water.

19. A thermally insulated pipeline, comprising:
a plastically deformed first pipe;
a plurality of spaced apart resilient sleeves coupled to the exterior of the first pipe; and
a second pipe coupled to the resilient sleeves.

20. The insulated pipeline of claim 19, further comprising:
thermal insulating material positioned within an annulus defined between the first and second pipes and interleaved among the resilient sleeves.

21. The insulated pipeline of claim 20, wherein one or more of the resilient sleeves include one or more longitudinal passages.

22. The insulated pipeline of claim 21, wherein at least some of the thermal insulating material is positioned within the longitudinal passages.

23. A method of operating a hydrocarbon production system for processing hydrocarbons that includes one or more hydrocarbon production sources and one or more hydrocarbon production destinations, comprising:
conveying hydrocarbons between the hydrocarbon production sources and the hydrocarbon destinations using one or more insulated pipelines; and
manufacturing at least one of the insulated pipelines by radially expanding and plastically deforming an inner rigid pipe within an outer rigid pipe.

24. The method of claim 23, further comprising:
positioning the outer rigid pipe at a location at which the at least one insulated pipeline will be used to convey fluidic materials through the interior of the first pipe; and
manufacturing the at least one insulated pipeline by radially expanding and plastically deforming the inner rigid pipe within the outer rigid pipe while the inner and outer rigid pipes are both positioned at the location at which the at least one insulated pipeline will be used to convey fluidic materials through the interior of the first pipe.

25. The method of claim 24, wherein the location at which the at least one insulated pipeline will be used to convey fluidic materials through the interior of the first pipe is below a body of water.

26. A method of manufacturing an insulated wellbore casing within a borehole that traverses a subterranean formation and includes a first wellbore casing coupled to and positioned within the wellbore, comprising:
positioning a second wellbore casing having a plurality of spaced apart resilient sleeves coupled to the exterior surface of the first pipe within the first wellbore casing; and
radially expanding and plastically deforming the second wellbore casing until the resilient sleeves engage the interior surface of the second pipe.

27. The method of claim 26, further comprising:
injecting an insulating material into an annulus defined between the first and second wellbore casings.

28. The method of claim 27, wherein injecting the insulating material into the annulus defined between the first and second wellbore casings comprises:
injecting the insulating material into the annulus defined between the first and second wellbore casings before radially expanding and plastically deforming the second wellbore casing.

29. The method of claim 27, wherein injecting the insulating material into the annulus defined between the first and second wellbore casings comprises:
injecting the insulating material into the annulus defined between the first and second wellbore casings after radially expanding and plastically deforming the second wellbore casing.

30. The method of claim 26, wherein the second wellbore casing further comprises:
a plurality of thermal insulating sleeves coupled to the exterior surface of the second wellbore casing and interleaved among the resilient sleeves.

31. A method of manufacturing an insulated pipeline, comprising:
positioning a first pipe having a plurality of spaced apart resilient sleeves coupled to the exterior surface of the first pipe within a second pipe;
radially expanding and plastically deforming the first pipe until the resilient sleeves engage the interior surface of the second pipe; and
injecting an insulating material into the annulus defined between the first and second pipes before radially expanding and plastically deforming the first pipe.

32. A method of manufacturing an insulated pipeline, comprising:
positioning a first pipe having a plurality of spaced apart resilient sleeves coupled to the exterior surface of the first pipe within a second pipe;
radially expanding and plastically deforming the first pipe until the resilient sleeves engage the interior surface of the second pipe; and
injecting an insulating material into the annulus defined between the first and second pipes after radially expanding and plastically deforming the first pipe.

33. A method of manufacturing an insulated pipeline, comprising:
positioning a first pipe having a plurality of spaced apart resilient sleeves coupled to the exterior surface of the first pipe within a second pipe;
radially expanding and plastically deforming the first pipe until the resilient sleeves engage the interior surface of the second pipe; and
injecting an insulating material into the annulus defined between the first and second pipes before and after radially expanding and plastically deforming the first pipe.

34. A method of manufacturing an insulated pipeline, comprising:
positioning a first pipe having a plurality of spaced apart resilient sleeves coupled to the exterior surface of the first pipe within a second pipe; and
radially expanding and plastically deforming the first pipe until the resilient sleeves engage the interior surface of the second pipe; and
injecting an insulating material into the annulus defined between the first and second pipes;
wherein the first pipe further comprises a plurality of thermal insulating sleeves coupled to the exterior surface of the first pipe and interleaved among the resilient sleeves.

35. A method of manufacturing an insulated pipeline, comprising:
positioning a first pipe beneath a body of water;
positioning a second pipe having the plurality of spaced apart resilient sleeves coupled to the exterior surface of the second pipe within the first pipe;
radially expanding and plastically deforming the second pipe until the resilient sleeves engage the interior surface of the first pipe; and
injecting an insulating material into the annulus defined between the first and second pipes;
wherein the second pipe further comprises a plurality of thermal insulating sleeves coupled to the exterior surface of the first pipe and interleaved among the resilient sleeves.

36. A system for manufacturing an insulated pipeline, comprising:
means for positioning a first pipe having a plurality of spaced apart resilient sleeves coupled to the exterior surface of the first pipe within a second pipe;
means for radially expanding and plastically deforming the first pipe until the resilient sleeves engage the interior surface of the second pipe; and
means for injecting an insulating material into the annulus defined between the first and second pipes before radially expanding and plastically deforming the first pipe.

37. A system for manufacturing an insulated pipeline, comprising:
means for positioning a first pipe having a plurality of spaced apart resilient sleeves coupled to the exterior surface of the first pipe within a second pipe;
means for radially expanding and plastically deforming the first pipe until the resilient sleeves engage the interior surface of the second pipe; and
means for injecting an insulating material into the annulus defined between the first and second pipes after radially expanding and plastically deforming the first pipe.

38. A system for manufacturing an insulated pipeline, comprising:
means for positioning a first pipe having a plurality of spaced apart resilient sleeves coupled to the exterior surface of the first pipe within a second pipe;
means for radially expanding and plastically deforming the first pipe until the resilient sleeves engage the interior surface of the second pipe; and
means for injecting an insulating material into the annulus defined between the first and second pipes before and after radially expanding and plastically deforming the first pipe.

39. A system for manufacturing an insulated pipeline, comprising:
means for positioning a first pipe having a plurality of spaced apart resilient sleeves coupled to the exterior surface of the first pipe within a second pipe;
means for radially expanding and plastically deforming the first pipe until the resilient sleeves engage the interior surface of the second pipe; and
means for injecting an insulating material into the annulus defined between the first and second pipes;
wherein the first pipe further comprises a plurality of thermal insulating sleeves coupled to the exterior surface of the first pipe and interleaved among the resilient sleeves.

40. A system for manufacturing an insulated pipeline, comprising:
means for positioning a first pipe beneath a body of water;
means for positioning a second pipe having the plurality of spaced apart resilient sleeves coupled to the exterior surface of the second pipe within the first pipe;
means for radially expanding and plastically deforming the second pipe until the resilient sleeves engage the interior surface of the first pipe; and
means for injecting an insulating material into the annulus defined between the first and second pipes;
wherein the second pipe further comprises a plurality of thermal insulating sleeves coupled to the exterior surface of the first pipe and interleaved among the resilient sleeves.

41. A method of manufacturing an insulated pipeline comprising an inner rigid pipe positioned within, coupled to, and thermally insulated from an outer rigid pipe, comprising:
manufacturing the insulated pipeline by radially expanding and plastically deforming the inner rigid pipe within the outer rigid pipe;
positioning the outer rigid pipe at a location at which the insulated pipeline will be used to convey fluidic materials through the interior of the first pipe; and
manufacturing the insulated pipeline by radially expanding and plastically deforming the inner rigid pipe within the outer rigid pipe while the inner and outer rigid pipes are both positioned at the location at which the insulated pipeline will be used to convey fluidic materials through the interior of the first pipe;
wherein the location at which the insulated pipeline will be used to convey fluidic materials through the interior of the first pipe is below a body of water.

42. A system for manufacturing an insulated pipeline comprising an inner rigid pipe positioned within, coupled to, and thermally insulated from an outer rigid pipe, comprising:
means for manufacturing the insulated pipeline by radially expanding and plastically deforming the inner rigid pipe within the outer rigid pipe;
means for positioning the outer rigid pipe at a location at which the insulated pipeline will be used to convey fluidic materials through the interior of the first pipe; and
means for manufacturing the insulated pipeline by radially expanding and plastically deforming the inner rigid pipe within the outer rigid pipe while the inner and outer rigid pipes are both positioned at the location at which the insulated pipeline will be used to convey fluidic materials through the interior of the first pipe;
wherein the location at which the insulated pipeline will be used to convey fluidic materials through the interior of the first pipe is below a body of water.

43. A thermally insulated pipeline, comprising:
a plastically deformed first pipe;
a plurality of spaced apart resilient sleeves coupled to the exterior of the first pipe;
a second pipe coupled to the resilient sleeves; and
thermal insulating material positioned within an annulus defined between the first and second pipes and interleaved among the resilient sleeves;
wherein one or more of the resilient sleeves include one or more longitudinal passages; and
wherein at least some of the thermal insulating material is positioned within the longitudinal passages.

44. A method of operating a hydrocarbon production system for processing hydrocarbons that includes one or more hydrocarbon production sources and one or more hydrocarbon production destinations, comprising:
conveying hydrocarbons between the hydrocarbon production sources and the hydrocarbon destinations using one or more insulated pipelines;
manufacturing at least one of the insulated pipelines by radially expanding and plastically deforming an inner rigid pipe within an outer rigid pipe;
positioning the outer rigid pipe at a location at which the at least one insulated pipeline will be used to convey fluidic materials through the interior of the first pipe; and
manufacturing the at least one insulated pipeline by radially expanding and plastically deforming the inner rigid pipe within the outer rigid pipe while the inner and outer rigid pipes are both positioned at the location at which the at least one insulated pipeline will be used to convey fluidic materials through the interior of the first pipe;
wherein the location at which the at least one insulated pipeline will be used to convey fluidic materials through the interior of the first pipe is below a body of water.

45. A method of manufacturing an insulated wellbore casing within a borehole that traverses a subterranean formation and includes a first wellbore casing coupled to and positioned within the wellbore, comprising:
positioning a second wellbore casing having a plurality of spaced apart resilient sleeves coupled to the exterior surface of the first pipe within the first wellbore casing;
radially expanding and plastically deforming the second wellbore casing until the resilient sleeves engage the interior surface of the second pipe; and
injecting the insulating material into the annulus defined between the first and second wellbore casings before radially expanding and plastically deforming the second wellbore casing.

46. A method of manufacturing an insulated wellbore casing within a borehole that traverses a subterranean formation and includes a first wellbore casing coupled to and positioned within the wellbore, comprising:
positioning a second wellbore casing having a plurality of spaced apart resilient sleeves coupled to the exterior surface of the first pipe within the first wellbore casing;
radially expanding and plastically deforming the second wellbore casing until the resilient sleeves engage the interior surface of the second pipe; and
injecting the insulating material into the annulus defined between the first and second wellbore casings after radially expanding and plastically deforming the second wellbore casing.

47. A method of manufacturing an insulated wellbore casing within a borehole that traverses a subterranean formation and includes a first wellbore casing coupled to and positioned within the wellbore, comprising:
positioning a second wellbore casing having a plurality of spaced apart resilient sleeves coupled to the exterior surface of the first pipe within the first wellbore casing;
radially expanding and plastically deforming the second wellbore casing until the resilient sleeves engage the interior surface of the second pipe; and
injecting the insulating material into the annulus defined between the first and second wellbore casings after radially expanding and plastically deforming the second wellbore casing;
wherein the second wellbore casing further comprises a plurality of thermal insulating sleeves coupled to the exterior surface of the second wellbore casing and interleaved among the resilient sleeves.

48. An hydrocarbon production system for processing hydrocarbons that includes one or more hydrocarbon production sources and one or more hydrocarbon production destinations, comprising:
means for conveying hydrocarbons between the hydrocarbon production sources and the hydrocarbon destinations using one or more insulated pipelines;
means for manufacturing at least one of the insulated pipelines by radially expanding and plastically deforming an inner rigid pipe within an outer rigid pipe;
means for positioning the outer rigid pipe at a location at which the at least one insulated pipeline will be used to convey fluidic materials through the interior of the first pipe; and
means for manufacturing the at least one insulated pipeline by radially expanding and plastically deforming the inner rigid pipe within the outer rigid pipe while the inner and outer rigid pipes are both positioned at the location at which the at least one insulated pipeline will be used to convey fluidic materials through the interior of the first pipe;
wherein the location at which the at least one insulated pipeline will be used to convey fluidic materials through the interior of the first pipe is below a body of water.

49. A system for manufacturing an insulated wellbore casing within a borehole that traverses a subterranean formation and includes a first wellbore casing coupled to and positioned within the wellbore, comprising:
means for positioning a second wellbore casing having a plurality of spaced apart resilient sleeves coupled to the exterior surface of the first pipe within the first wellbore casing;
means for radially expanding and plastically deforming the second wellbore casing until the resilient sleeves engage the interior surface of the second pipe; and
means for injecting the insulating material into the annulus defined between the first and second wellbore casings before radially expanding and plastically deforming the second wellbore casing.

50. A system for manufacturing an insulated wellbore casing within a borehole that traverses a subterranean formation and includes a first wellbore casing coupled to and positioned within the wellbore, comprising:
means for positioning a second wellbore casing having a plurality of spaced apart resilient sleeves coupled to the exterior surface of the first pipe within the first wellbore casing;
means for radially expanding and plastically deforming the second wellbore casing until the resilient sleeves engage the interior surface of the second pipe; and
means for injecting the insulating material into the annulus defined between the first and second wellbore casings after radially expanding and plastically deforming the second wellbore casing.

51. A system for manufacturing an insulated wellbore casing within a borehole that traverses a subterranean formation and includes a first wellbore casing coupled to and positioned within the wellbore, comprising:
means for positioning a second wellbore casing having a plurality of spaced apart resilient sleeves coupled to the exterior surface of the first pipe within the first wellbore casing;
means for radially expanding and plastically deforming the second wellbore casing until the resilient sleeves engage the interior surface of the second pipe; and
means for injecting the insulating material into the annulus defined between the first and second wellbore casings after radially expanding and plastically deforming the second wellbore casing;
wherein the second wellbore casing further comprises a plurality of thermal insulating sleeves coupled to the exterior surface of the second wellbore casing and interleaved among the resilient sleeves.
